(19) United States
(12) Patent Application Publication
(10) Pub. No.: US 2026/0032562 A1
(43) Pub. Date: Jan. 29, 2026

(54) TECHNIQUE FOR ENABLING AN APPLICATION TO ACCESS A TARGET NETWORK FUNCTION

(71) Applicant: Telefonaktiebolaget LM Ericsson (publ), Stockholm (SE)

(72) Inventors: Massimo CONDOLUCI, Solna (SE); Thorsten LOHMAR, Aachen (DE); Tomas NYLANDER, Värmdö (SE); Ralf KELLER, Würselen (DE)

(21) Appl. No.: 19/099,353

(22) PCT Filed: Aug. 1, 2022
(86) PCT No.: PCT/EP2022/071555

§ 371 Date: Jan. 28, 2025

(51) Int. Cl. H04W 48/04; H04W 8/02; H04W 48/16

(52) U.S. Cl. CPC H04W 48/04; H04W 8/02; H04W 48/16

(57) ABSTRACT

A technique for enabling an application to access a target network function in a visited mobile communication network is disclosed, wherein the target network function provides a service with respect to one or more wireless devices associated with the application that have roamed from a home mobile communication network to the visited mobile communication network. A method implementation of the technique is performed by a network function of the home mobile communication network and includes obtaining accessibility information on how the target network function can be accessed in the visited mobile communication network, and providing, based on the accessibility information, access information to the application enabling the application to access the target network function.

### TECHNICAL FIELD

The present disclosure generally relates to mobile communication systems. In particular, a technique for enabling an application to access a target network function in a visited mobile communication network is presented. The technique may be embodied in methods, computer programs, apparatuses and systems.

### BACKGROUND

In mobile communication systems, Original Equipment Manufacturers (OEMs) often operate globally and the User Equipments (UEs) they provide may be present in many countries over the world. When moving across regions, the UEs may be roaming through different mobile networks accordingly. In the automotive industry, for example, vehicles may be connected to OEM backend systems which provide telematics and other functions, wherein backend systems may be centralized applications serving a large area, such as a complete continent, for example. The connected vehicles require cellular connectivity provided by the local/national mobile operators, wherein OEMs typically rely on roaming agreements which allow the vehicles (or UEs in general) to roam across the different networks.

As Mobile Network Operators (MNOs) may compete against each other, there may be a certain reluctance to share topology or performance information among the operators in roaming scenarios. While an MNO may have a partner relationship with an OEM so that it may be acceptable to share some information with the OEM, it may nevertheless not be acceptable to share information with another MNO. In some industries, there may also be interest in exposure functions providing exposure information on network connectivity, performance, etc., which may enable OEMs to adapt their algorithms depending on network status and performance, for example.

In practice, different types of roaming may be used. One variant of roaming is called Home Routing (HR), where the user plane is routed back to the home mobile network and Internet access is provided by the home mobile network, i.e., only the radio part is used in the visited mobile network. Another variant of roaming is called Local BreakOut (LBO) roaming, where the user plane is handled by the visited mobile network, which also provides the Internet access. In other words, in the HR case, the user plane traffic is redirected from the Visited Public Land Mobile Network (V-PLMN) to the Home Public Land Mobile Network (H-PLMN) before reaching the Internet, whereas, in the LBO case, the user plane is not redirected to the H-PLMN, i.e., direct access to the Internet may be provided from the V-PLMN. The HR and LBO roaming cases are defined by 3GPP, mainly in TS 23.501 and TS 23.502.

FIGS. 1 and 2 illustrate how exposure of network information or notifications (e.g., event exposure, analytics exposure) could work in HR and LBO scenarios, wherein FIG. 1 shows the HR roaming case and FIG. 2 shows the LBO roaming case. In the shown examples, it is assumed that the UE has roamed from the H-PLMN to the V-PLMN and that the network entity that generates the network information or notification to be exposed (e.g., an Access and Mobility Management Function (AMF), shown as “Event Producer” 102 in the figures—it will be understood that other entities could generate exposure information, such as a Network Data Analytics Function (NWDAF) or a Session Management Function (SMF), for example) is always located at the V-PLMN. The network entity that exposes the network information or notification (indicated by “Event Exposure” 104 in the figures) to the application that is interested in the information or notification (e.g., an Application Function (AF), shown as “Event Consumer” 106 in the figures) could be a Network Exposure Function (NEF), for example. As shown, the AF may interact with the NEF to request and obtain the network information or notification, and eventually provide the exposed information or notification to a client application at the UE (shown as “Event Consumer (Client)” 108 in the figures). In the HR case, as shown in FIG. 1, the entity providing the exposure service (i.e., the NEF) is located at the H-PLMN and, consequently, the AF interacts with the NEF of the H-PLMN and the NEF at the H-PLMN directly interacts with the relevant event producer in the V-PLMN (e.g., the AMF). On the other hand, in the LBO case, as shown in FIG. 2, the entity providing the exposure service (i.e., the NEF) is located at the V-PLMN, i.e., the AF (in this case located in the V-PLMN) would directly interact with the NEF located at the V-PLMN. Interaction between network functions (NFs) of two different PLMNs may generally be handled via Security Edge Protection Proxies (SEPPs) of the two networks via the roaming interface N32, for example.

Exposure functions specified by 3GPP which may be employed in scenarios like the above examples may comprise the following. For event exposure allowing the monitoring of specific events via the NEF (e.g., loss of connectivity as detected by AMF, UE reachability as detected by AMF, roaming status as detected by Unified Data Management (UDM), etc.), the Nnef_EventExposure service defined in TS 23.502 may be used by an NF (e.g., AF) to subscribe to receiving an event and to be notified when the event occurs (service operations: Nnef_EventExposure_Subscribe to subscribe to receiving an event, Nnef_EventExposure_Notify to report an event by the NEF that has previously been subscribed). For the above-mentioned event “roaming status” as detected by the UDM, the Nudm_EventExposure service defined in TS 23.502 may be used by the NEF to subscribe to receiving the roaming status from the UDM (service operations: Nudm_EventExposure_Subscribe to subscribe to receiving an event from the UDM, Nudm_EventExposure_Notify to report an event by the UDM that has previously been subscribed). For analytics exposure allowing to obtain specific analytics information exposed by the NEF (e.g., slice load level, observed service experience, network performance analytics, etc.), the Nnef_AnalyticsExposure service defined in TS 23.502 and TS 23.288 may be used by an NF (e.g., AF) to subscribe to receiving analytics and to be notified when the analytics is generated (service operations: Nnef_AnalyticsExposure_Subscribe to subscribe to receiving analytics information and Nnef_AnalyticsExposure_Notify to report analytics information by the NEF that has previously been subscribed). TS 23.502 further provides definitions for the discovery of NFs in the network, such as using a Network Repository Function (NRF). A corresponding service operation is the Nnrf_NFDiscovery_Request which provides the Internet Protocol (IP) address or the Fully Qualified Domain Name (FQDN) of the expected NF instance, for example.

FIG. 3 illustrates an example of roaming activation for network exposure when there is a change of the network function in charge of exposure (e.g., the NEF) from the H-PLMN to the V-PLMN. When LBO roaming is used in such a case, the AF (corresponding to the event consumer 106) is expected to be connected to the NEF (corresponding to the event exposure 104) of the V-PLMN after the roaming in order to be able to obtain event information from the visited network. This means that the AF (e.g., an OEM backend system) should know
(1) that a UE (e.g., vehicle; shown as “App Client” in the figure, corresponding to event exposure client 108) has now roamed to a visited network (i.e., the UE has changed its serving PLMN), and
(2) how the NEF of the PLMN serving the UE (i.e., the NEF of the V-PLMN after the roaming) can be reached.

In conventional systems, however, a problem is that such information is not available to the AF. In the vehicle context, this means that the OEM backend system currently does not know how to reach the NEF of each PLMN its associated vehicles could be connected to, for example.

It will be understood that the above LBO case is just one example in which such problem may occur and that similar problems may be present in other use cases where the target NEF (or another network function of interest) is located in the V-PLMN. Even in HR roaming cases, for example, such problem may be given when the target NEF is located in the V-PLMN and the V-PLMN wants to deliver information directly to the AF without going through the NEF of the H-PLMN. In such cases, even when the user plane data is thus routed through the home network, notifications e.g. for event or analytics exposure may need to be exposed through the NEF of the V-PLMN. However, as said, on-demand information about an NEF in a V-PLMN is not available to the AF. Providing this information in a manual fashion might not be practically feasible due to the high number of possible PLMNs, causing complexity and scalability issues which are even worsened in case of topology changes involving the addition of new NEFs, for example.

Furthermore, considering the HR case, e.g., when the AF accesses network exposure services by the NEF of the H-PLMN, another problem may be that the V-PLMN may wish to filter information provided to the H-PLMN for security or confidentiality reasons (e.g., to avoid revealing certain information to another network operator). Such filtering functionality for information to be exposed is normally part of the NEF's functionality but, in HR scenarios, the exposing network functions in the V-PLMN (e.g., AMF, SMF, NWDAF, etc.) would directly interact with the NEF at the H-PLMN so that the information would already arrive in an unfiltered manner in the H-PLMN. When filtering of the information to be exposed to the H-PLMN is to be performed in the V-PLMN, on the other hand, complexity may be significantly increased since, then, any network function in the V-PLMN should have filtering capabilities. The complexity even further increases if different filtering policies for different H-PLMNs are to be enforced in the V-PLMN, for example.

### SUMMARY

Accordingly, there is a need for a technique that enables an application (e.g., AF) to access a target network function (e.g., NEF) in a visited network when wireless devices (e.g., UEs) serviced by the application roam from a home network to the visited network.

According to a first aspect, a method for enabling an application to access a target network function in a visited mobile communication network is provided. The target network function provides a service with respect to one or more wireless devices associated with the application that have roamed from a home mobile communication network to the visited mobile communication network. The method is performed by a network function of the home mobile communication network and comprises obtaining accessibility information on how the target network function can be accessed in the visited mobile communication network. The method further comprises providing, based on the accessibility information, access information to the application enabling the application to access the target network function.

The accessibility information may be preconfigured in a data repository of the home mobile communication network and obtaining the accessibility information may include retrieving the accessibility information from the data repository.

In another variant, obtaining the accessibility information may include receiving the accessibility information from a network function of the visited mobile communication network. In this variant, the network function of the visited mobile communication network may provide the accessibility information when the one or more wireless devices register at the visited mobile communication network when roaming from the home mobile communication network to the visited mobile communication network.

In yet another variant, obtaining the accessibility information may include receiving the accessibility information from a network function of the visited mobile communication network. In this variant, the network function of the visited mobile communication network may provide, upon receiving a request from the network function of the home mobile communication network, a response to the network function of the home mobile communication network including the accessibility information. The request and the response may be piggybacked on messages exchanged between the network function of the home mobile communication network and the network function of the visited mobile communication network for other purposes than requesting and providing the accessibility information.

The method may further comprise receiving, prior to obtaining the accessibility information, a subscription request from the application requesting notification in case wireless devices associated with the application have roamed from the home mobile communication network to the visited mobile communication network. The access information may then be provided to the application as part of a notification of the subscription.

In another variant, the method may further comprise receiving, prior to obtaining the accessibility information, a dedicated request from the application requesting the access information in order to be able to access the target network function. In this variant, the access information may then be provided to the application in a dedicated response to the request.

The accessibility information may include at least one of interaction allowance information indicating whether or not direct interaction between the application and the target network function is allowed, and target network function access information indicating how the target network function can be accessed. When the interaction allowance information included in the accessibility information indicates that direct interaction between the application and the target network function is allowed, the access information provided to the application may comprise the target network function access information, enabling the application to directly interact with the target network function. When the interaction allowance information included in the accessibility information indicates that direct interaction between the application and the target network function is not allowed, the access information provided to the application may indicate that the application is to indirectly interact with the target network function via the network function of the home mobile communication network.

In the latter case, the method may further comprise receiving, from the application, a request to access the target network function, translating the request into a corresponding request to access the target network function in the visited mobile communication network, sending the translated request to the target network function, receiving, from the target network function, a response to the request, translating the response into a corresponding response to be sent to the application, and sending the translated response to the application. The response may contain information that is filtered by the target network function to avoid exposure of information available in the visited mobile communication network to the home mobile communication network.

The network function of the home mobile communication network may be an NEF of the home mobile communication network and the target network function may be an NEF of the visited mobile communication network.

According to a second aspect, a method for enabling an application to access a target network function in a visited mobile communication network is provided. The target network function provides a service with respect to one or more wireless devices associated with the application that have roamed from a home mobile communication network to the visited mobile communication network. The method is performed by the application and comprises receiving, from a network function of the home mobile communication network, access information enabling the application to access the target network function. The access information is provided by the network function of the home mobile communication network based on accessibility information on how the target network function can be accessed in the visited mobile communication network. The method further comprises accessing the target network function using the access information.

The method according to the second aspect may define a method from the perspective of an application described above in relation to the method according to the first aspect. The method may further comprise sending, prior to receiving the access information, a subscription request to the network function of the home mobile communication network requesting notification in case wireless devices associated with the application have roamed from the home mobile communication network to the visited mobile communication network. The access information may then be received from the network function of the home mobile communication network as part of a notification of the subscription.

In another variant, the method may further comprise sending, prior to receiving the access information, a dedicated request to the network function of the home mobile communication network requesting the access information in order to be able to access the target network function. The access information may then be received from the network function of the home mobile communication network in a dedicated response to the request.

The accessibility information may include at least one of interaction allowance information indicating whether or not direct interaction between the application and the target network function is allowed, and target network function access information indicating how the target network function can be accessed. When the interaction allowance information included in the accessibility information indicates that direct interaction between the application and the target network function is allowed, the access information received by the application may comprise the target network function access information, enabling the application to directly interact with the target network function. When the interaction allowance information included in the accessibility information indicates that direct interaction between the application and the target network function is not allowed, the access information received by the application may indicate that the application is to indirectly interact with the target network function via the network function of the home mobile communication network.

In the latter case, accessing the target network function using the access information may comprise sending, to the network function of the home mobile communication network, a request to access the target network function, wherein the request is to be translated by the network function of the home mobile communication network into a corresponding request to access the target network function in the visited mobile communication network, wherein the translated request is to be sent by the network function of the home mobile communication network to the target network function, and receiving, from the network function of the home mobile communication network, a response to the request, the response being originally sent by the target network function and being translated by the network function of the home mobile communication network into a corresponding response to be sent to the application. The response may contain information that is filtered by the target network function to avoid exposure of information available in the visited mobile communication network to the home mobile communication network.

The network function of the home mobile communication network may be an NEF of the home mobile communication network and the target network function may be an NEF of the visited mobile communication network.

According to a third aspect, a method for enabling an application to access a target network function in a visited mobile communication network is provided. The target network function provides a service with respect to one or more wireless devices associated with the application that have roamed from a home mobile communication network to the visited mobile communication network. The method is performed by the target network function and comprises sending, to a network function of the home mobile communication network, accessibility information on how the target network function can be accessed in the visited mobile communication network, the accessibility information to be used by the network function of the home mobile communication network to provide access information to the application enabling the application to access the target network function.

The method according to the third aspect may define a method from the perspective of a target network function described above in relation to the method according to the first aspect and the second aspect. The accessibility information may be sent to the network function of the home mobile communication network when the one or more wireless devices register at the visited mobile communication network when roaming from the home mobile communication network to the visited mobile communication network.

In another variant, upon receiving a request to provide the accessibility information from the network function of the home mobile communication network, a response may be sent to the network function of the home mobile communication network including the accessibility information. The request and the response may be piggybacked on messages exchanged between the network function of the home mobile communication network and the target network function for other purposes than requesting and providing the accessibility information.

The accessibility information may include at least one of interaction allowance information indicating whether or not direct interaction between the application and the target network function is allowed, and target network function access information indicating how the target network function can be accessed. When the interaction allowance information included in the accessibility information indicates that direct interaction between the application and the target network function is allowed, the access information provided by the network function of the home mobile communication network to the application may comprise the target network function access information to enable the application to directly interact with the target network function. When the interaction allowance information included in the accessibility information indicates that direct interaction between the application and the target network function is not allowed, the access information provided by the network function of the home mobile communication network to the application may indicate that the application is to indirectly interact with the target network function via the network function of the home mobile communication network.

In the latter case, the method may further comprise receiving, from the network function of the home mobile communication network, a request to access the target network function, the request being originally sent by the application and being translated by the network function of the home mobile communication network into a corresponding request to access the target network function in the visited mobile communication network and sending, to the network function of the home mobile communication network, a response to the request, wherein the response is to be translated by the network function of the home mobile communication network into a corresponding response to be sent to the application, wherein the translated response is to be sent by the network function of the home mobile communication network to the application. The response may contain information that is filtered by the target network function to avoid exposure of information available in the visited mobile communication network to the home mobile communication network.

The network function of the home mobile communication network may be an NEF of the home mobile communication network and the target network function to be an NEF of the visited mobile communication network.

According to a fourth aspect, a computer program product is provided. The computer program product comprises program code portions for performing the method of at least one of the first, the second and the third aspect when the computer program product is executed on one or more computing devices (e.g., a processor or a distributed set of processors). The computer program product may be stored on a computer readable recording medium, such as a semiconductor memory, DVD, CD-ROM, and so on.

According to a fifth aspect, a computing unit a configured to execute a network function of a home mobile communication network for enabling an application to access a target network function in a visited mobile communication network is provided. The target network function provides a service with respect to one or more wireless devices associated with the application that have roamed from the home mobile communication network to the visited mobile communication network. The computing unit comprises at least one processor and at least one memory, the at least one memory containing instructions executable by the at least one processor such that the network function of the home mobile communication network is operable to perform any of the method steps presented herein with respect to the first aspect.

According to a sixth aspect, a computing unit configured to execute an application for enabling the application to access a target network function in a visited mobile communication network is provided. The target network function provides a service with respect to one or more wireless devices associated with the application that have roamed from a home mobile communication network to the visited mobile communication network. The computing unit comprises at least one processor and at least one memory, the at least one memory containing instructions executable by the at least one processor such that the application is operable to perform any of the method steps presented herein with respect to the second aspect.

According to a seventh aspect, a computing unit configured to execute a target network function for enabling an application to access the target network function in a visited mobile communication network is provided. The target network function provides a service with respect to one or more wireless devices associated with the application that have roamed from a home mobile communication network to the visited mobile communication network. The computing unit comprises at least one processor and at least one memory, the at least one memory containing instructions executable by the at least one processor such that the target network function is operable to perform any of the method steps presented herein with respect to the third aspect.

According to an eighth aspect, there is provided a system comprising a computing unit of the fifth aspect, a computing unit of the sixth aspect, and a computing unit of the seventh aspect.

### BRIEF DESCRIPTION OF THE DRAWINGS

Implementations of the technique presented herein are described herein below with reference to the accompanying drawings, in which:

FIGS. 1 and 2 illustrate mobile network architectures exemplifying how exposure of network information or notifications could work in HR and LBO scenarios, wherein FIG. 1 relates to an HR roaming case and FIG. 2 relates to an LBO roaming case;

FIG. 3 illustrates an example of roaming activation for network exposure when there is a change of the network function in charge of exposure (i.e., NEF) from an H-PLMN to a V-PLMN;

FIGS. 4a to 4c illustrate exemplary compositions of a computing unit configured to execute a home network function, a computing unit configured to execute an application, and a computing unit configured to execute a target network function according to the present disclosure;

FIG. 5 illustrates a method which may be performed by the home network function according to the present disclosure;

FIG. 6 illustrates a signaling diagram of an exemplary interaction between a home network function (H-NEF) and a target network function (V-NEF), and optionally other network functions (NFs) in the home mobile communication network, according to the present disclosure;

FIG. 7a illustrates a signaling diagram of an exemplary interaction between an application (AF) and a home network function (H-NEF) in which access information is provided to the application as part of a subscription-based communication according to the present disclosure;

FIG. 7b illustrates a signaling diagram of an exemplary interaction between an application (AF) and a home network function (H-NEF) in which access information is provided to the application as part of a dedicated request/response-based communication according to the present disclosure;

FIG. 8 illustrates a signaling diagram of an exemplary interaction between an application (AF) which indirectly accesses the services of a target network function (V-NEF) via a home network function (H-NEF) according to the present disclosure;

FIG. 9 illustrates a method which may be performed by the application according to the present disclosure; and

FIG. 10 illustrates a method which may be performed by the target network function according to the present disclosure.

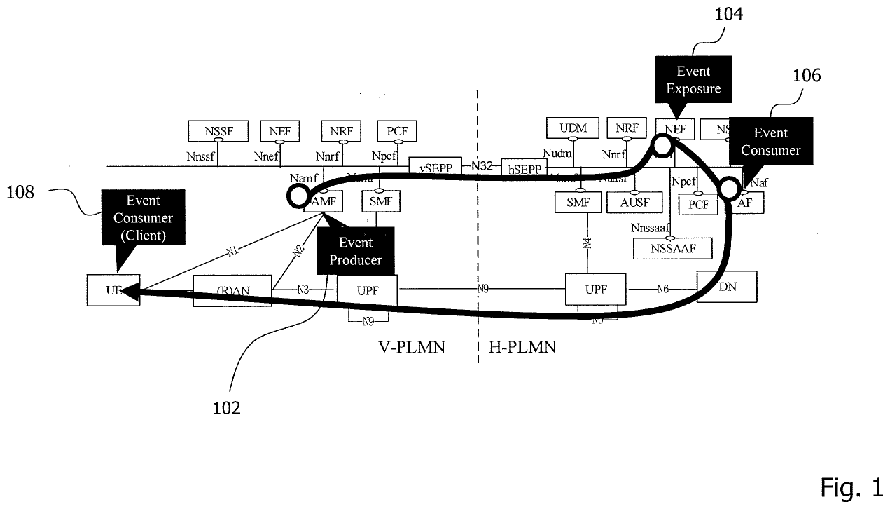

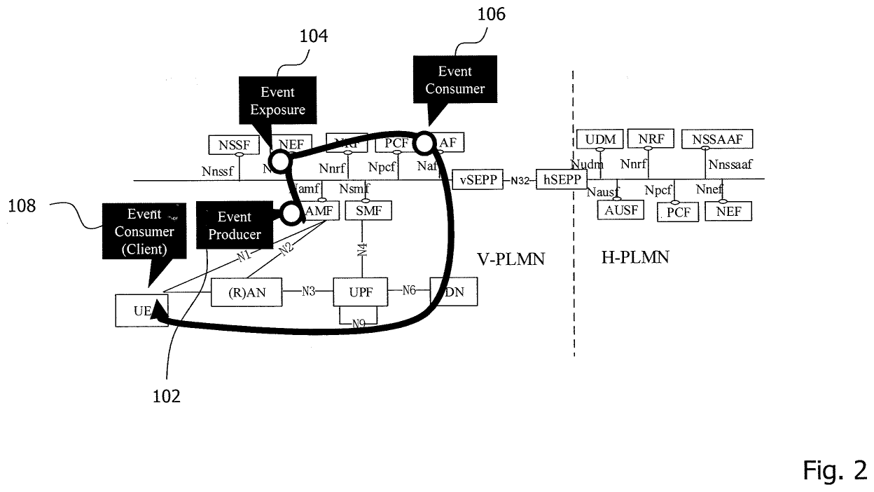

### DETAILED DESCRIPTION

In the following description, for purposes of explanation and not limitation, specific details are set forth in order to provide a thorough understanding of the present disclosure. It will be apparent to one skilled in the art that the present disclosure may be practiced in other embodiments that depart from these specific details.

Those skilled in the art will further appreciate that the steps, services and functions explained herein below may be implemented using individual hardware circuitry, using software functioning in conjunction with a programmed micro-processor or general purpose computer, using one or more application specific integrated circuits (ASICs) and/or using one or more digital signal processors (DSPs). It will also be appreciated that when the present disclosure is described in terms of a method, it may also be embodied in one or more processors and one or more memories coupled to the one or more processors, wherein the one or more memories are encoded with one or more programs that perform the steps, services and functions disclosed herein when executed by the one or more processors.

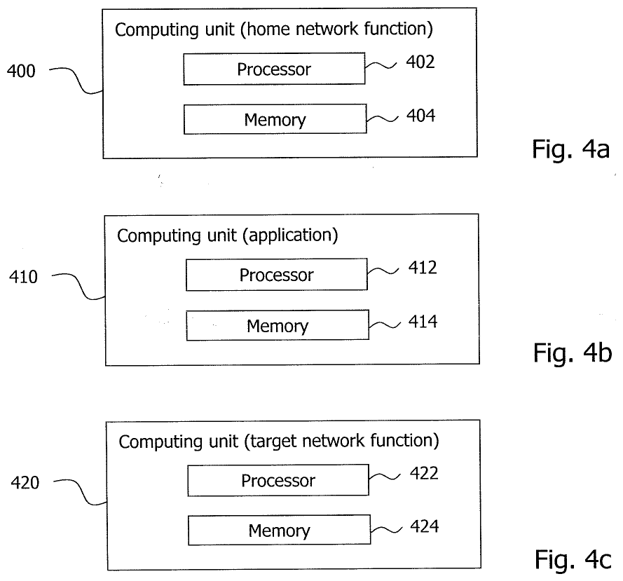

FIG. 4a schematically illustrates an exemplary composition of a computing unit 400 configured to execute a network function of a home mobile communication network for enabling an application to access a target network function in a visited mobile communication network. The target network function provides a service with respect to one or more wireless devices associated with the application that have roamed from the home mobile communication network to the visited mobile communication network. The computing unit 400 comprises at least one processor 402 and at least one memory 404, wherein the at least one memory 404 contains instructions executable by the at least one processor 402 such that the network function of the home mobile communication network is operable to carry out the method steps described herein below with reference to the “home network function”.

FIG. 4b schematically illustrates an exemplary composition of a computing unit 410 configured to execute an application for enabling the application to access a target network function in a visited mobile communication network. The target network function provides a service with respect to one or more wireless devices associated with the application that have roamed from a home mobile communication network to the visited mobile communication network. The computing unit 410 comprises at least one processor 412 and at least one memory 414, wherein the at least one memory 414 contains instructions executable by the at least one processor 412 such that the application is operable to carry out the method steps described herein below with reference to the “application”.

FIG. 4c schematically illustrates an exemplary composition of a computing unit 420 configured to execute a target network function for enabling an application to access the target network function in a visited mobile communication network. The target network function provides a service with respect to one or more wireless devices associated with the application that have roamed from a home mobile communication network to the visited mobile communication network. The computing unit 420 comprises at least one processor 422 and at least one memory 424, wherein the at least one memory 424 contains instructions executable by the at least one processor 422 such that the target network function is operable to carry out the method steps described herein below with reference to the “target network function”.

It will be understood that each of the computing unit 400, the computing unit 410 and the computing unit 420 may be implemented on a physical computing unit or a virtualized computing unit, such as a virtual machine, for example. It will further be appreciated that each of the computing unit 400, the computing unit 410 and the computing unit 420 may not necessarily be implemented on a standalone computing unit, but may be implemented as components—realized in software and/or hardware—residing on multiple distributed computing units as well, such as in a cloud computing environment, for example.

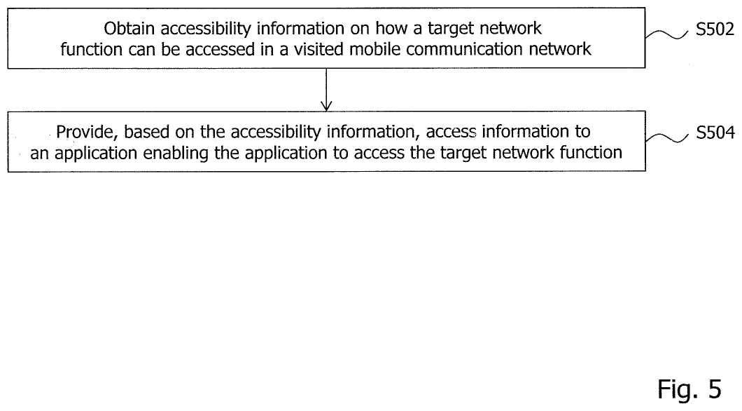

FIG. 5 illustrates a method which may be performed by the network function of the home mobile communication network executed on the computing unit 400 according to the present disclosure. The network function of the home mobile communication network may in the following—for brevity of reference-also be referred to as “home network function”. The method is dedicated to enabling an application (e.g., the application executed on computing unit 410) to access a target network function (e.g., the target network function executed on computing unit 420) in a visited mobile communication network. The target network function provides a service with respect to one or more wireless devices associated with the application that have roamed from the home mobile communication network to the visited mobile communication network. In step S502, the home network function may obtain accessibility information on how the target network function can be accessed in the visited mobile communication network. In step S504, the home network function may provide, based on the accessibility information, access information to the application enabling the application to access the target network function.

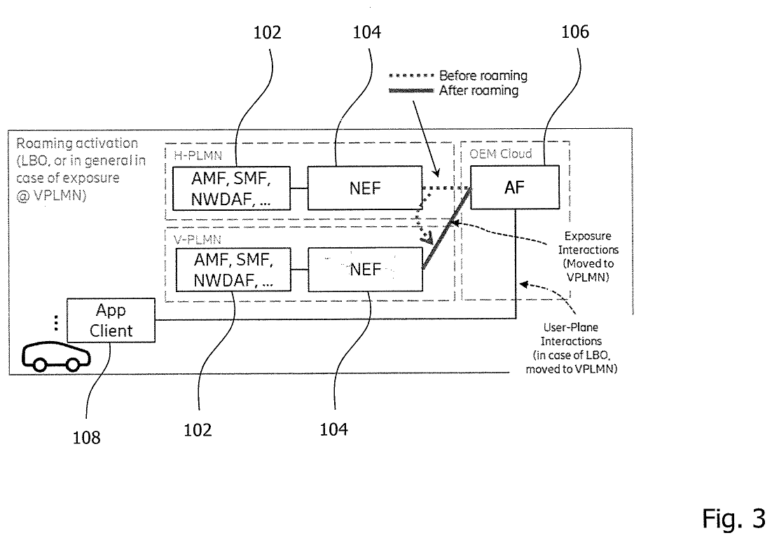

The home network function may thus be a network function residing in the home mobile communication network, such as a H-PLMN, and the target network function may be a network function residing in the visited mobile communication network, such as a V-PLMN, wherein the one or more wireless devices associated with the application may roam from the home mobile communication network to the visited mobile communication network. The home network function and the target network function may be network functions of the same type, wherein, through the roaming, the network function in charge of providing the service with respect to the one or more wireless devices to the application may change from the home network function (responsible of providing the service to the application in the home mobile communication network) to the target network function (responsible of providing the service to the application in the visited mobile communication network). The target network function may in other words take over the role of providing the service to the application once the one or more wireless devices have roamed from the home mobile communication network to the visited mobile communication network. This situation may be just like in the conventional LBO roaming case described above in relation to FIG. 3, for example, where the NEF of the H-PLMN (corresponding to the home network function) may change to the NEF of the V-PLMN (corresponding to the target network function) as the network function responsible of providing the service to the application (AF in FIG. 3) with respect to the one or more wireless devices (vehicles in FIG. 3) that have roamed from the H-PLMN to the V-PLMN.

Rather than in the conventional LBO roaming case of FIG. 3, however, according to the technique presented herein, a technique is provided that may allow the application (AF in FIG. 3) to know how the target network function in the visited mobile communication network (NEF of the V-PLMN in FIG. 3) can be reached, so that the application may access the target network function even though the target network function is in the visited mobile communication network, and so that, after roaming, the service may be continued to be provided to the application (e.g., upon request by the application) by the target network function from the visited mobile communication network. In accordance with steps S502 and S504, this knowledge may be conveyed to the application by the home network function, which may obtain the accessibility information on how the target network function can be accessed in the visited mobile communication network (step S502) and provide, based on the accessibility information, the access information to the application enabling the application to access the target network function (step S504).

The service provided by the target network function with respect to the one or more wireless devices to the application from the visited mobile communication network (and likewise provided by the home network function with respect to the one or more wireless devices to the application from the home mobile communication network, i.e., prior to the roaming of the wireless devices to the visited mobile communication network) may be any service that is provided to the application with respect to the one or more wireless devices. Like in the example of FIG. 3, the home network function may be an NEF of the home mobile communication network and the target network function may be an NEF of the visited mobile communication network. The service may in this case be an exposure service provided to the application by the respective NEFs (the application being the “event consumer”). The one or more wireless devices may be UEs of the respective mobile communication networks, and the wireless devices may be “associated with” the application in the sense that the application may be in (e.g., continuous) communication with the wireless devices (e.g., via the user plane of the home or visited mobile communication network) to carry out some (e.g., collaborative) task, such as in a client-server relationship, for example. The application may communicate with the wireless devices at application layer and, in some implementations, the application may be an AF of a mobile communication network, for example.

While, in the following description, examples will mostly be given with respect to the above exposure service related use case in which the home network function and the target network function are given by respective NEFs providing exposure services to an AF, it will be understood that various other use cases with other entities are generally conceivable. The following description shall thus not be construed to be limited to such examples. As a mere example, instead of an AF, the “application” could be given by a Vehicle-to-Everything (V2X) application specific server and, instead of NEFs, the “home and target network functions” may be given by respective V2X Application Enabler (VAE) servers (which may change due to roaming), wherein the V2X application specific server may obtain services via the VAE servers. In another example, the application could be given by a VAE server and the home and target network functions may be given by respective NEFs (which may change due to roaming), wherein the VAE server may obtain services (e.g., to be offered to a V2X application specific server) via the NEFs. In still another example related to the Common Application Programming Interface (API) Framework (CAPIF) defined by 3GPP TS 23.222, the application could be given by an API invoker and the home and target network functions may be given by respective CAPIF Core Functions: (CCFs) and/or API Exposing Functions (AEFs), wherein the API invoker obtains services via the CCFs/AEFs (which may change due to roaming).

As said, by obtaining accessibility information on how the target network function can be accessed in the visited mobile communication network (in accordance with step S502) and providing, based on the accessibility information, access information to the application enabling the application to access the target network function (in accordance with step S504), the home network function may convey knowledge to the application on how the target network function in the visited mobile communication network can be reached.

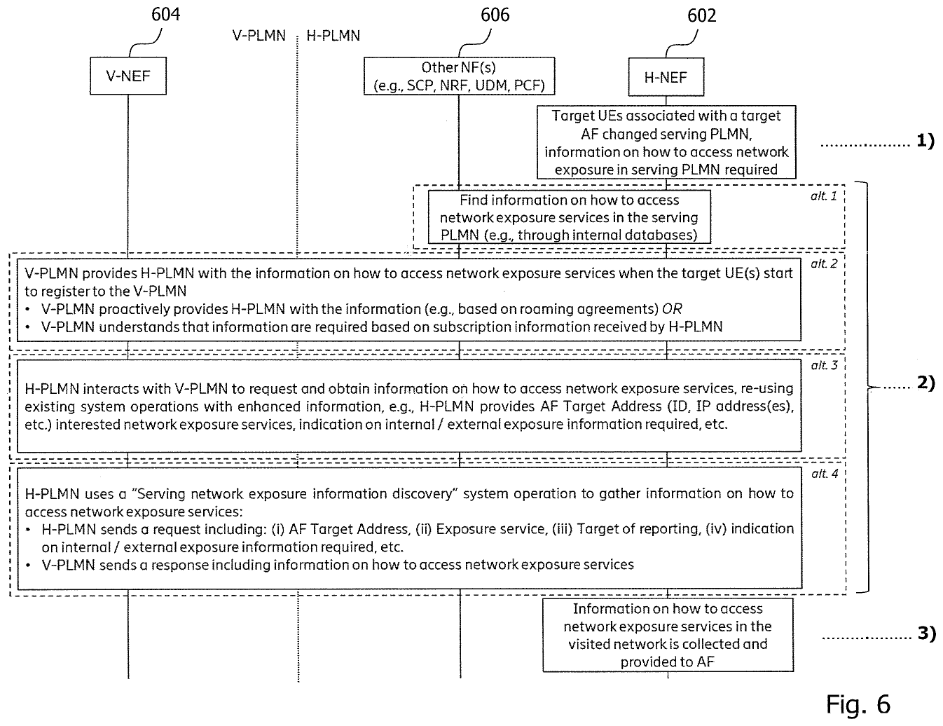

In this regard, it will be understood that obtaining the accessibility information in accordance with step S502 may be implemented in various ways. In the following, such variants will be generally described, wherein each variant will be accompanied by a more detailed description of an exemplary implementation with reference to FIG. 6 in order to exemplify the respective variant in a more illustrative manner. FIG. 6 illustrates a signaling diagram of an exemplary interaction between an NEF of the home mobile communication network (being representative of an exemplary “home network function”) and an NEF of the visited mobile communication network (being representative of an exemplary “target network function”), and optionally other network functions (NFs) in the home mobile communication network. The home and visited mobile communication networks are exemplarily indicated as H- PLMN and V-PLMN in the figure. As a nomenclature for the remainder of this disclosure, the prefix “H-” will generally be used to denote an entity of the home mobile communication network and the prefix “V-” will generally be used to denote an entity of the visited mobile communication network. The H-NEF 602 shown in FIG. 6 thus denotes an NEF of the home mobile communication network (H-PLMN) and the V-NEF 604 denotes an NEF of the visited mobile communication network (H-PLMN). It will be understood that the H-NEF 602 and the V-NEF 604 are merely exemplary for a “home network function” and for a “target network function” in the exposure service related use case described herein and that also other network functions (NFs) could generally be used as “home and target network functions” in other use cases.

As an initial step 1) of the interaction of FIG. 6, the H-NEF 602 may become aware of the fact that one or more UEs (not shown) associated with the AF (or, more generally, the “application”; also not shown) have roamed to the V-PLMN and may become aware of the PLMN ID of the V-PLMN. In one example, this may take place: following a reception of a corresponding notification from an H-UDM (e.g., the H-NEF 602 may receive a Nudm_EventExposure_Notify message from a H-UDM including newServingPlmn information). In another example, this may take place following a reception of an explicit/dedicated request from the AF requesting the access information to be able to access the V-NEF 604 in the visited mobile communication network (such explicit/dedicated request may imply that UEs have roamed to the V-PLMN). In step 2) of FIG. 6, the H-NEF 602 may then trigger discovery of the information on how to access exposure services in the visited mobile communication network, i.e., to obtain the accessibility information for the target network function (here, the V-NEF 604) in accordance with step S502.

In a first variant of obtaining the accessibility information, the accessibility information may be preconfigured in a data repository of the home mobile communication network, wherein obtaining the accessibility information may include retrieving the accessibility information from the data repository. Such variant is indicated as alternative 1 (“alt. 1”) in FIG. 6. In this variant, the information on how to access the exposure services for the V-PLMN may be preconfigured in a data repository (e.g., a database) of the H-PLMN, wherein the data repository may be provided at the H-NEF 602 itself, or-as indicated in the figure-the H-NEF 602 may retrieve the relevant information from a data repository hosted by one or more other network functions (NFs) 606 of the H-PLMN, such as a Service Communication Proxy (SCP), an NRF, a UDM, a Policy Control Function (PCF), or the like. The data repository may contain records, such as <PLMN ID, serving network exposure information>or <PLMN ID, exposure service, serving network exposure information>in order to be able to identify relevant information from the repository, wherein “serving network exposure information” could be populated by an MNO depending on e.g. roaming agreements or configurations among roaming operators, or could be populated according to e.g. GSMA configurations, etc.

In a second variant of obtaining the accessibility information, obtaining the accessibility information may include receiving the accessibility information from a network function of the visited mobile communication network (e.g., the target network function), wherein the network function of the visited communication network may (e.g., automatically) provide the accessibility information when the one or more wireless devices register at the visited mobile communication network when roaming from the home mobile communication network to the visited mobile communication network. Such variant is indicated as alternative 2 (“alt. 2”) in FIG. 6. In this variant, the V-NEF 604 (optionally, in collaboration with other network functions of the visited mobile communication network) may provide the accessibility information when roaming UEs start to register at the V-PLMN and the V-PLMN starts to interact with the H-PLMN accordingly. In one possible realization, when the V-PLMN starts interacting with the H-PLMN to inform the H-PLMN that a corresponding UE has started registering with the V-PLMN, the V-NEF 604 may proactively provide the H-NEF 602 with the accessibility information, e.g., together with other information that may normally be provided to the home network function in such situations (e.g., supported network services for the roaming UEs). The accessibility information may generally be provided to any H-PLMN, or depending on a roaming agreement, for example. In another possible realization, instead of proactively providing the accessibility information, the V-NEF 604 could also provide the H-NEF 602 with the accessibility information in response to subscriber information received from the home network function (e.g., the subscriber information may include a request to request the accessibility information from the V-PLMN), for example.

In a third variant of obtaining the accessibility information, obtaining the accessibility information may include receiving the accessibility information from a network function of the visited mobile communication network, wherein the network function of the visited mobile communication network may provide, upon receiving a request from the network function of the home mobile communication network, a response to the network function of the home mobile communication network including the accessibility information. In one alternative of the third variant, the request and the response may be piggybacked on messages exchanged between the network function of the home mobile communication network and the network function of the visited mobile communication network for other purposes than requesting and providing the accessibility information. Such variant is indicated as alternative 3 (“alt. 3”) in FIG. 6. In this variant, the H-NEF 602 may interact with the V-NEF 604 to request and obtain the accessibility information, wherein the request and the response may be piggybacked on other messages exchanged between these entities.

For example, an existing system operation may be reused, or be adequately extended to this end. As a mere example, the H-NEF 602 could reuse the system operation “Delegated service discovery when NF service consumer and NF service producer are in different PLMNs” and/or reuse the “Nnrf_NFDiscovery_Request” message which may involve other network functions, such as an NRF/SCP, for example. As an example for extending exchanged messages by additional information, the H-NEF 602 could add to the request e.g. information about the AF target address (e.g., ID, IP address, etc.), interested network exposure services, indications on whether the accessibility information should be in the form of internal or external identifiers, or the like.

In another alternative of the third variant, the request and the response may be represented by a dedicated request/response scheme specifically tailored to requesting and providing the accessibility information. Such variant is indicated as alternative 4 (“alt. 4”) in FIG. 6. In this variant, a new system operation (e.g., called “Serving network exposure information discovery”) that is specifically tailored to requesting and obtaining the accessibility information by a network entity of the H-PLMN (here, the H-NEF 602) from the V-PLMN (here, from the V-NEF 604) may be introduced. The system operation may be implemented in the form of a request/response scheme, for example. A corresponding request (e.g., “Serving network exposure information discovery Request”) could include at least one of the following information: (i) AF target address, (ii) exposure services (list of exposure services, e.g., event IDs and/or analytic IDs that the AF uses in the H-PLMN), (iii) target of reporting (GPSI, SUPI, External Group Identifier of UEs which are now served by the V-PLMN), and (iv) an indication on whether internal or external V-NEF information should be provided. A corresponding response (e.g., “Serving network exposure information discovery Response”) may then include the requested accessibility information accordingly.

Finally, in step 3) of FIG. 6, once the accessibility information is received by the H-NEF 602, the H-NEF 602 may provide the AF (or more generally, the “application”) with information based on the received accessibility information, e.g., with the “access information” enabling the AF to access the target network function in the visited mobile communication network (here, the V-NEF 604) in accordance with step S504, as described above.

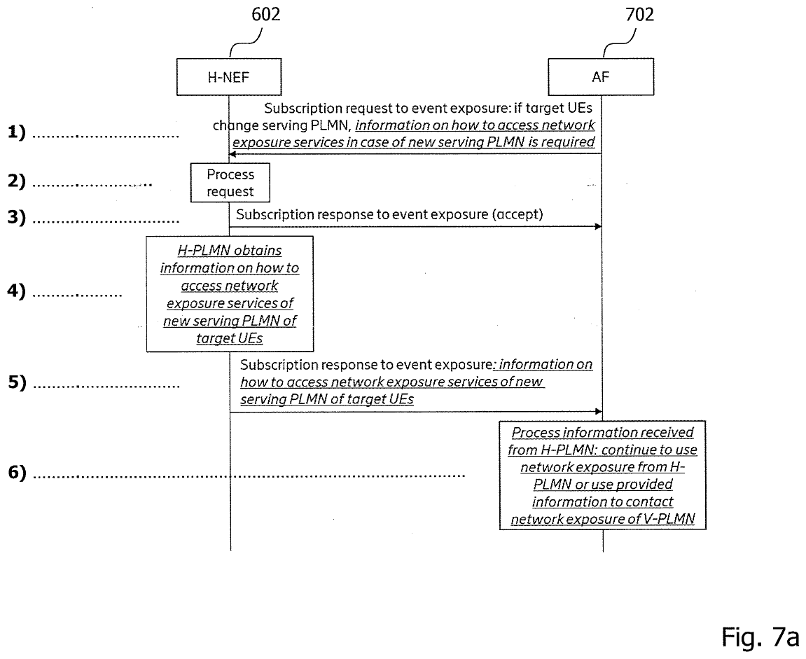

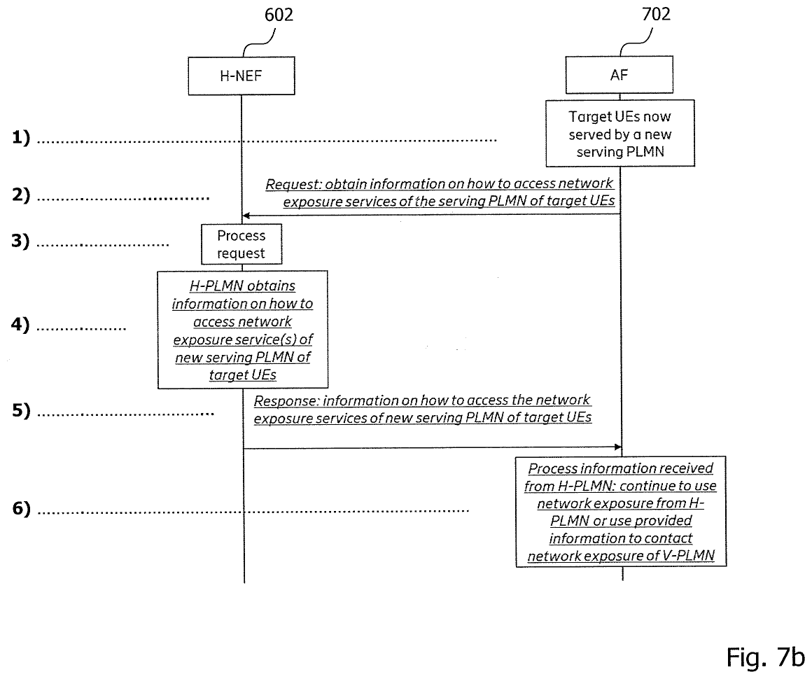

As far as the provision of access information to the application based on the accessibility information in accordance with step S504 is concerned, it will be understood that, before the access information is provided to the application, the application (e.g., AF) may inform the home network function that the application is in need of obtaining the access information in order to be able to access the target network function in the visited mobile communication network when the one or more wireless devices have roamed to the visited mobile communication network. Such need may be communicated by the application to the home network function in different ways. In the following, such variants will be generally described, wherein each variant will be accompanied by a more detailed description of an exemplary implementation with reference to FIG. 7a and FIG. 7b (each of which continues the example of FIG. 6) to exemplify the respective variant in a more illustrative manner.

In a first variant of informing the home network function that the application is in need of obtaining the access information, the home network function may receive, prior to obtaining the accessibility information, a subscription request from the application requesting notification in case wireless devices associated with the application have roamed from the home mobile communication network to the visited mobile communication network. The access information may then be provided to the application as part of a notification of the subscription. To this end, a system operation for event exposure may be extended by an indication used by the application (e.g., AF) during the subscription to event exposure to inform the H-PLMN (here, the H-NEF) about its interest in (or “need of”) receiving the access information to be able to access the target network function (here, the V-NEF) in the visited mobile communication network.

FIG. 7a illustrates a signaling diagram of an exemplary interaction between the application, here exemplarily indicated as AF 702, and the H-NEF 602. In step 1) of the interaction, the AF 702 may subscribe to the H-NEF 602 for event exposure. In the subscription request, the AF 702 may add an indication to inform the H-NEF 602 that information on how to access network exposure services in case UEs associated with the AF 702 roam to the V-PLMN. In one possible realization, this indication could be made using the Nnef_EventExposure_Subscribe system operation, wherein, in the Nnef_EventExposure_Subscribe Request message, the AF may use the existing eventID=“roamingStatus” and add an additional tag (e.g., “Serving network exposure information”), wherein this tag may indicate that, in addition to the legacy outputs of the event “roaming status” (e.g., roaming and newServingPlmn), the AF 702 also wants to receive information on how to access the network exposure services offered by the V-PLMN. In another possible realization, the indication could likewise be made using the Nnef_EventExposure_Subscribe system operation, wherein, in the Nnef_EventExposure_Subscribe Request message, the AF 702 may use a newly introduced (specific) event ID, such as eventID=“roamingStatusWithServingNetworkExposureInformation”, for example.

In step 2) of the interaction, the H-NEF 602 may process the request from the AF 702. This processing may in some cases involve interaction with other network functions (e.g., H-PCF) to check whether the AF is authorized to receive serving network exposure information in case of roaming, to check whether the target UEs are authorized for LBO or HR roaming, or the like. Considering the above example, to give the possibility to the H-NEF 602 to gather information about the roaming status of the target UEs, the H-NEF 602 could subscribe to an H-UDM for event exposure of the roaming status (e.g., using the Nudm_EventExposure_Subscribe service operation) upon reception of a Nnef_EventExposure_Subscribe Request message from the AF 702 indicating eventID=“roamingStatus” (or eventID=“roamingStatusWithServingNetworkExposureInformation”), as described above. In step 3) of the interaction, the H-NEF 602 may then provide an event exposure subscription response to the AF 702 indicating whether the request has been accepted. In one possible realization, this could be done by sending a Nnef_EventExposure_Subscribe Response message to the AF 702, for example.

In step 4) of the interaction, when one or more target UEs have changed their serving PLMN, i.e., have roamed to the V-PLMN, the H-NEF 602 may obtain the accessibility information from the V-PLMN in line with one of the variants described above in relation to FIG. 6 (e.g., one of alternatives 1 to 4). Still considering the above example, information about the roaming event for a certain UE may be obtained by reception of a notification from the H-UDM, e.g., the H-NEF 602 could receive a Nudm_EventExposure_Notify message from the H-UDM including the roaming and newServingPlmn information. In step 5) of the interaction, the H-NEF 602 may then provide, based on the obtained accessibility information, the access information (in accordance with step S504) to the AF 702 as part of a notification of the subscription. In one possible realization, the H-NEF 602 may send a Nnef_EventExposure_Notify message to the AF 702 to this end, wherein the message may include eventID=“roamingStatus” or eventID=“roamingStatusWithServingNetworkExposureInformation” (depending on the eventID of the original request) as well as the access information. In step 6) of the interaction, the AF 702 may finally use the received access information to learn how the exposure services are to be accessed in the visited mobile communication network and, then, to access the target network function (here, the V-NEF 604) accordingly.

In a second variant of informing the home network function that the application is in need of obtaining the access information, the home network function may receive, prior to obtaining the accessibility information, a dedicated request from the application requesting the access information in order to be able to access the target network function. The access information may then be provided to the application in a dedicated response to the request. To this end, capabilities of the network may be extended by a new system operation that allows the application (e.g., AF) to request and obtain the access information from the H-PLMN, i.e., from the home network function.

FIG. 7b illustrates a signaling diagram of an exemplary interaction between the application, here again exemplarily indicated as AF 702, and the H-NEF 602. The interaction of FIG. 7b is similar to that of FIG. 7a, the essential difference being that-instead of a subscription based request and notification-an explicit/dedicated request and response specifically tailored to requesting and obtaining the access information is employed. In the following, only the differences to the example of FIG. 7a will be explained in order to avoid unnecessary repetitions.

As an initial step 1) of the interaction of FIG. 7b, the AF 702 may become aware of the fact that one or more UEs (not shown) associated with the AF 702 have roamed to the V-PLMN and may become aware of the PLMN ID of the V-PLMN. In one example, this information may be obtained by the AF 702 using the Nnef_EventExposure_Subscribe system operation to subscribe to eventID=“roamingStatus”, which may trigger a notification from the H-NEF 602 to the AF 702 when a target UE has roamed to the V-PLMN, wherein the notification may include the newServingPlmn, for example. In another example, this information may be obtained by the AF 702 via application layer signaling, e.g., an application client at UE site may fetch the plmnID from the UE chipset and provide it to the AF 702 (e.g., via an application server).

In step 2) of FIG. 7b, the AF 702 may then use the new system operation enabling a dedicated request/response scheme to request and obtain the access information. In one possible realization, a “Serving network exposure information” system operation may be employed, for example. Using this system operation, the AF 702 may then send a “Serving network exposure information Request” to the H-NEF 602, wherein this message could include at least one of the following information: (i) target (GPSI, SUPI, External Group Identifier or Internal Group Identifier), (ii) PLMN ID, and (iii) exposure services (list of exposure services, e.g., event IDs and/or analytic IDs the AF 702 is interested in. The “target” information may indicate the UEs that have roamed to the V-PLMN identified by the PLMN ID, for example.

The following steps 3) and 4) may be identical to steps 2) and 4) of the example of FIG. 7a. In step 5) of FIG. 7b, the H-NEF 602 may provide the determined access information to the AF 702 via a dedicated response to the dedicated request of step 2) described above. In one possible realization, using the “Serving network exposure information” system operation, the H-NEF 602 may send a “Serving network exposure information Response” message to the AF 702 including the access information enabling the AF to access the target network function (here, the V-NEF 604) in the visited mobile communication network. The following step 6) may then again be identical to step 6) of the example of FIG. 7a.

In the above general description as well as the above description of examples, reference has been made to the “accessibility information” on how the target network function can be accessed in the visited mobile communication network (obtained in step S502) and to the “access information” which may be, based on the accessibility information, provided to the application to enable the application to access the target network function (in accordance with step S504). In the following, both the “accessibility information” and the “access information” derived therefrom will be elucidated in more detail.

The “accessibility information” may include at least one of “interaction allowance information” indicating whether or not direct interaction between the application and the target network function is allowed and “target network function access information” indicating how the target network function can be accessed. The interaction allowance information could be a flag indicating whether the V-PLMN and the target network function residing therein (e.g., the V-NEF) allow direct interaction with the application (e.g., AF) for accessing the (e.g., network exposure) services for the roaming UEs, or whether only indirect interaction via the home network function (e.g., the H-NEF) is allowed. The flag could be provided in the form of a tag “ServingPlmnExposure”, for example, which may indicate whether or not the V-PLMN allows direct interaction with the application accordingly. The target network function access information, on the other hand, may comprise at least one of the following information allowing the target network function to be accessed: (i) FQDN of the target network function, (ii) IP address of the target network function, (iii) Uniform Resource Identifier (URI) and/or Uniform Resource Locator (URL) of the target network function, (iv) additional target network function information gathered by the home network function that could be used by the application in the upcoming interaction with the target network function (e.g., an authorization token), and (v) exposure services (list of exposure services, e.g., event IDs and/or analytic IDs that are provided by the target network function).

The interaction allowance information may be used to decide what kind of “access information” is to be provided to the application. When the interaction allowance information included in the accessibility information indicates that direct interaction between the application and the target network function is allowed, the access information provided to the application may comprise the target network function access information, enabling the application directly interact with the target network function. In other words, if direct interaction is allowed, the target network function access information (or at least a portion thereof) may be reused for the access information provided to the application in order to enable the application to reach the target network function. On the other hand, when the interaction allowance information included in the accessibility information indicates that direct information between the application and the target network function is not allowed, the access information provided to the application may indicate that the application is to indirectly interact with the target network function via the network function of the home mobile communication network. In other words, if direct interaction is not allowed, the access information may comprise directions instructing the application to indirectly interact with the target network function via the home network function.

Once the access information is provided to the application, the application (e.g., AF) may use the access information to understand how the target network function is to be accessed and proceed to access the target network function accordingly. With reference to both steps 6) of FIGS. 7a and 7b, if the access information received from the H-NEF 602 indicates that the V-PLMN allows direct interactions with the AF 702, then the AF 702 may use the provided information to contact the network exposure services of the V-PLMN, i.e., the V-NEF 604. For example, the AF 702 could interact with the V-NEF 604 to subscribe to particular exposure services, optionally using the additional target network function information contained in the access information, such as an authorization token needed for the subscription, for example. If, on the other hand, the access information received from the H-NEF 602 indicates that the V-PLMN does not allow direct interactions with the AF 702, then the AF 702 may continue to interact with the H-NEF 602 to access network exposure services in the visited network, wherein the H-NEF 602 may operate as an intermediary entity via which the AF 702 may indirectly interact with the target network function in the V-PLMN, i.e., the V-NEF 604.

In the latter case, i.e., when the application is to indirectly interact with the target network function via the home network function, the method performed by the home network function may further comprise receiving, from the application, a request to access the target network function, translating the request into a corresponding request to access the target network function in the visited mobile communication network, sending the translated request to the target network function, receiving, from the target network function, a response to the request, translating the response into a corresponding response to be sent to the application, and sending the translated response to the application. In case of an exposure service related use case, when the target network function is a V-NEF, as in the examples described above, the response to the request may contain exposure information collected by the target network function from another network function of the visited mobile communication network, such as an AMF, SMF, NWDAF of the V-PLMN, or the like. In order to avoid exposing information to the home mobile communication network, e.g., because certain portions of the exposed information may not the desired by the MNO of the visited mobile communication network to be disclosed to the MNO of the home mobile communication network, the response may contain information that is filtered by the target method function to avoid exposure of information available in the visited mobile communication network to the home mobile communication network.

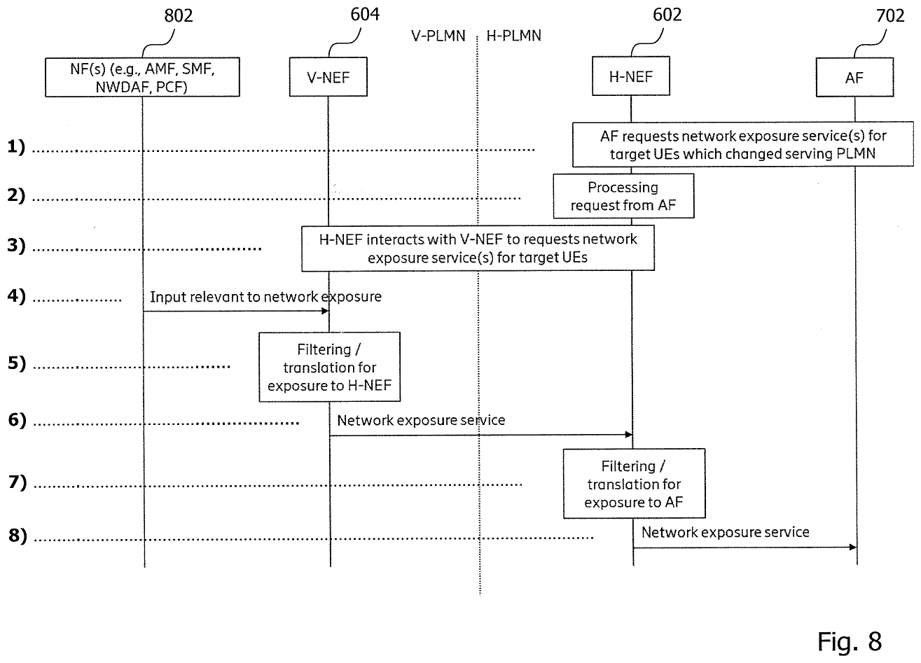

In the following, a more detailed description of an exemplary implementation of such indirect interaction between the application and the target network function via the home network function will be provided with reference to FIG. 8 in order to exemplify the possible interaction in a more illustrative manner. Continuing the above examples, the application is exemplarily indicated as the AF 702, the home network function by the H-NEF 602, and the target network function by the V-NEF 604.

In an initial step 1) of the interaction, the AF 702 may interact with the H-NEF 602 (i.e., with the NEF it may be allowed to interact with by default in the H-PLMN) to subscribe to network exposure services for one or more target UEs that have roamed to the V-PLMN, i.e., which have changed their serving PLMN and are now served by the V-PLMN. Interaction between the AF 702 and the H-NEF 602 may be performed in accordance with 3GPP standard procedures for network exposure services request/subscription. In step 2) of the interaction, the H-NEF 602 may process the request from the AF 702, wherein the processing may involve interactions with other network functions required to understand whether the AF 702 is authorized to access the required service, as well as involve obtaining the accessibility information on how the network exposure services in the V-PLMN, i.e., the V-NEF 604, can be accessed. This can be done in line with the variants described above in relation to FIG. 6 (e.g., one of alternatives 1 to 4), for example. For the example of FIG. 8, it is assumed that the interaction allowance information included in the accessibility information indicates that direct interaction between the AF 702 and the V-NEF 604 (i.e., the target network function) is not allowed, so that the AF 702 is to indirectly interact with the V-NEF 604 via the H-NEF 602. The processing of step 2) could also include translating the network exposure services request received from the AF 702 and generating a network exposure services request to be sent to the V-NEF 604 accordingly, if needed, for example.

In step 3) of the interaction, the H-NEF 602 may then interact with the V-NEF 604 to subscribe to (or “request”) a network exposure service for the target UEs associated with the AF 702, e.g., based on the initial request from the AF 702. This interaction may be implemented using an extension of 3GPP standard procedures for network exposure services requests/subscription, wherein the H-NEF 602 may become a consumer of the services offered by the V-NEF 604. Upon receiving a response to the request/subscription from the V-NEF 604 (e.g., acceptance or refusal), the H-NEF 602 may translate such response and generate a corresponding response/subscription response to the AF 702. Such interaction may be performed via the roaming interface N32 through the SEPPs of the H-PLMN and the V-PLMN, for example.

In step 4 of the interaction, the V-NEF 604 may handle the requested network exposure service, e.g., by interacting with the relevant event producer(s) 802 in the V-PLMN (which may include network functions (NFs) in the V-PLMN, such as an AMF, SMF, NWDAF, PCF, or the like, as described above) in order to receive the input relevant for the requested network exposure service. Such input could be provided in the form of network events to be exposed, information related to policy (acceptance of requested policy, policy change, etc.) to be exposed, network analytics information to be exposed, or the like. In step 5 of the interaction, the V-NEF 604 may process the information received from the event producer(s) 802, wherein such processing may include filtering and/or translating the information to be exposed to the H-PLMN. Filtering and/or translating the information may include aggregating the information before exposure, removing certain information before exposure, lowering granularity of information before exposure, applying classification to the information before exposure (e.g., a parameter at the V-NEF 604 presented as a numerical value may be associated with a certain class of ranges to hide its actual value), or the like. As mentioned above, such filtering may be employed to avoid exposure of information available in the V-PLMN that the MNO of the V-PLMN wishes to hide from an MNO of the H-PLMN, for example.

In step 6 of the interaction, the V-NEF 604 may provide the network exposure services to the H-NEF 602 accordingly. As said, this may be implemented using 3GPP standard procedures for network exposure, e.g., in the form of a response to a request or as a notification in case of a subscription-based service. In step 7 of the interaction, the H-NEF 602 may process the information received from the V-NEF 604 and may provide, in step 8 of the interaction, the processed information to the AF 702 as the final step of the network exposure service. Also this step may be implemented using 3GPP standard procedures for network exposure services, e.g., in the form of a response to a request or as a notification in case of a subscription-based service. The processing of step 7 of the interaction could also involve some filtering and/or translation of the information received from the V-NEF 604 before being exposed to the AF, if needed.

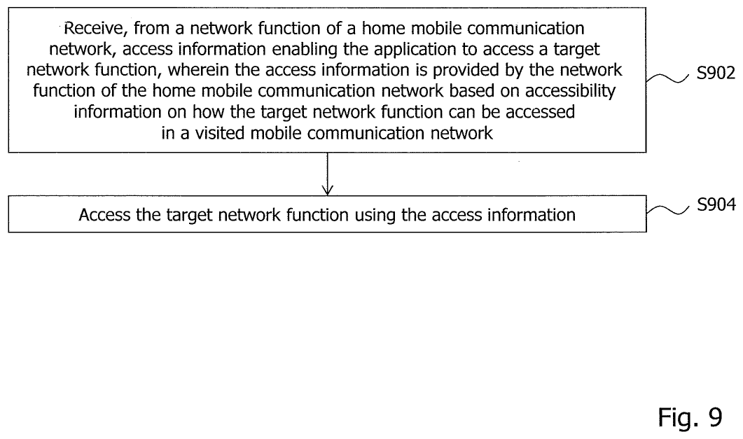

FIG. 9 illustrates a method which may be performed by the application executed on the computing unit 410 according to the present disclosure. The method is dedicated to enabling the application to access a target network function (e.g., the target network function executed on computing unit 420) in a visited mobile communication network. The target network function provides a service with respect to one or more wireless devices associated with the application that have roamed from a home mobile communication network to the visited mobile communication network. The operation of the application may as such be complementary to the operation of the home network function as well as the target network function described above in relation to FIGS. 5 to 8 and, as such, aspects described above with regard to the operation of the application may be applicable to the operation of the application described in the following as well, and vice versa. Unnecessary repetitions are thus omitted in the following.

In step S902, the application may receive, from a network function of the home mobile communication network (e.g., the home network function executed on computing unit 400), access information enabling the application to access the target network function, wherein the access information is provided by the network function of the home mobile communication network based on accessibility information on how the target network function can be accessed in the visited mobile communication network. In step S904, the application may access the target network function using the access information.

As described above in relation to FIGS. 5 to 8, the method may further comprise sending, prior to receiving the access information, a subscription request to the network function of the home mobile communication network requesting notification in case wireless devices associated with the application have roamed from the home mobile communication network to the visited mobile communication network. The access information may then be received from the network function of the home mobile communication network as part of a notification of the subscription. In another variant, the method may further comprise sending, prior to receiving the access information, a dedicated request to the network function of the home mobile communication network requesting the access information in order to be able to access the target network function. The access information may then be received from the network function of the home mobile communication network in a dedicated response to the request.

The accessibility information may include at least one of interaction allowance information indicating whether or not direct interaction between the application and the target network function is allowed, and target network function access information indicating how the target network function can be accessed. When the interaction allowance information included in the accessibility information indicates that direct interaction between the application and the target network function is allowed, the access information received by the application may comprise the target network function access information, enabling the application to directly interact with the target network function. When the interaction allowance information included in the accessibility information indicates that direct interaction between the application and the target network function is not allowed, the access information received by the application may indicate that the application is to indirectly interact with the target network function via the network function of the home mobile communication network.

In the latter case, accessing the target network function using the access information may comprise sending, to the network function of the home mobile communication network, a request to access the target network function, wherein the request is to be translated by the network function of the home mobile communication network into a corresponding request to access the target network function in the visited mobile communication network, wherein the translated request is to be sent by the network function of the home mobile communication network to the target network function, and receiving, from the network function of the home mobile communication network, a response to the request, the response being originally sent by the target network function and being translated by the network function of the home mobile communication network into a corresponding response to be sent to the application. The response may contain information that is filtered by the target network function to avoid exposure of information available in the visited mobile communication network to the home mobile communication network.

The network function of the home mobile communication network may be an NEF of the home mobile communication network and the target network function may be an NEF of the visited mobile communication network.

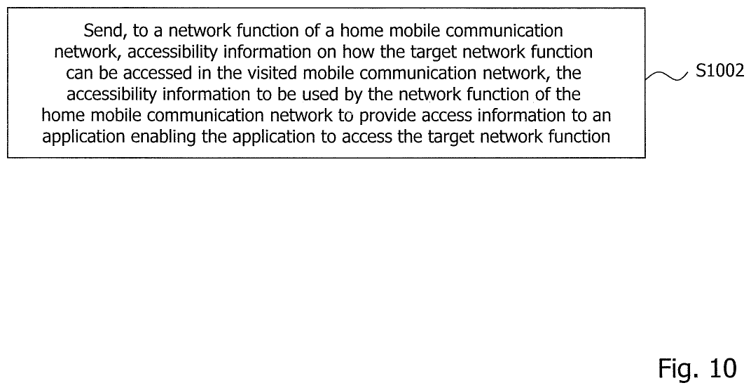

FIG. 10 illustrates a method which may be performed by the target network function executed on the computing unit 420 according to the present disclosure. The method is dedicated to enabling an application (e.g., the application executed on computing unit 410) to access the target network function in a visited mobile communication network. The target network function provides a service with respect to one or more wireless devices associated with the application that have roamed from a home mobile communication network to the visited mobile communication network. The operation of the target network function may as such be complementary to the operation of the home network function as well as the application described above in relation to FIGS. 5 to 9 and, as such, aspects described above with regard to the operation of the target network function may be applicable to the operation of the target network function described in the following as well, and vice versa. Unnecessary repetitions are thus omitted in the following.

In step S1002, the target network function may send, to a network function of the home mobile communication network (e.g., the home network function executed on computing unit 400), accessibility information on how the target network function can be accessed in the visited mobile communication network, the accessibility information to be used by the network function of the home mobile communication network to provide access information to the application enabling the application to access the target network function.

As described above in relation to FIGS. 5 to 9, the accessibility information may be sent to the network function of the home mobile communication network when the one or more wireless devices register at the visited mobile communication network when roaming from the home mobile communication network to the visited mobile communication network. In another variant, upon receiving a request to provide the accessibility information from the network function of the home mobile communication network, a response may be sent to the network function of the home mobile communication network including the accessibility information. The request and the response may be piggybacked on messages exchanged between the network function of the home mobile communication network and the target network function for other purposes than requesting and providing the accessibility information.

The accessibility information may include at least one of interaction allowance information indicating whether or not direct interaction between the application and the target network function is allowed, and target network function access information indicating how the target network function can be accessed. When the interaction allowance information included in the accessibility information indicates that direct interaction between the application and the target network function is allowed, the access information provided by the network function of the home mobile communication network to the application may comprise the target network function access information to enable the application to directly interact with the target network function. When the interaction allowance information included in the accessibility information indicates that direct interaction between the application and the target network function is not allowed, the access information provided by the network function of the home mobile communication network to the application may indicate that the application is to indirectly interact with the target network function via the network function of the home mobile communication network.

In the latter case, the method may further comprise receiving, from the network function of the home mobile communication network, a request to access the target network function, the request being originally sent by the application and being translated by the network function of the home mobile communication network into a corresponding request to access the target network function in the visited mobile communication network and sending, to the network function of the home mobile communication network, a response to the request, wherein the response is to be translated by the network function of the home mobile communication network into a corresponding response to be sent to the application, wherein the translated response is to be sent by the network function of the home mobile communication network to the application. The response may contain information that is filtered by the target network function to avoid exposure of information available in the visited mobile communication network to the home mobile communication network.

The network function of the home mobile communication network may be an NEF of the home mobile communication network and the target network function to be an NEF of the visited mobile communication network.

As has become apparent from the above, the present disclosure provides a technique for enabling an application to access a target network function in a visited mobile communication network. In general, the presented technique may enable a home network (e.g., an H-PLMN) to gather information on how to access services in the serving network (e.g., V-PLMN) when wireless devices change their serving network and, if allowed by the V-PLMN, to provide information on how to reach the service (e.g., a network exposure service provided by an NEF) of the V-PLMN to an application (e.g., AF) associated with the wireless devices. If, on the other hand, the V-PLMN does not allow a direct interaction with the AF, the AF may access the services via a home network function (e.g., NEF of the H-PLMN) which then interacts with the target network function (e.g., NEF of the V-PLMN) as an intermediate entity. With such solution, an application which requires services, such as network exposure services, for its operations may always know how to access such services in the V-PLMN when corresponding target wireless devices (e.g., UEs) roam to the different network.

Advantages of the presented technique may also be summarized in that mobile networks may be enabled to efficiently support use cases requiring continuity of services, such as network exposure services, in roaming scenarios. Increased availability of services may thus be provided in roaming scenarios, and such advantage may be provided while reducing the implementation burden for network users/customers with global connectivity requirements (e.g., an automotive OEM), for example. The technique may be particularly valuable for roaming scenarios where the application backend (e.g., AF) needs to interact directly with the service functionality (e.g., NEF) located in the V-PLMN, e.g., such as in LBO roaming cases. Here, especially use cases with exposure functionality at the V-PLMN may be expected to be of high interest for industries, including the automotive industry. Furthermore, since MNOs may compete against each other, as described above, for use cases involving exposure of network information or notifications, the visited operator may not need to pass potentially business critical information through a competitor to a business partner.

In this respect, the presented technique may consider cases of network exposure with an HR roaming approach where the NEF in the H-PLMN interacts with the NEF in the V-PLMN (instead of the NEF in the H-PLMN directly interacting with NFs in the V-PLMN), and this may enable the V-PLMN to reuse its own NEF for performing functionalities, such as filtering of information (that should not be revealed) to be exposed to the H-PLMN. The V-PLMN may thus also use a single point of enforcement of such filtering rules (e.g., the NEF at the V-PLMN which interacts with the NEF at the H-PLMN), contrary to conventional approaches, where the V-PLMN should have such rules in place at each NF interacting with the NEF of the H-PLMN. The H-NEF to V-NEF interaction may also be advantageous in that multiple network exposure services could be supported with a single roaming integration among the PLMNs, which may facilitate scalability and introduction of new network exposure services without the need for new roaming integration tests. This may be contrary to conventional solutions (where the H-NEF directly interacts with NFs of the V-PLMN), in which a separate roaming integration would be needed for each NF the H-NEF may be interacting with.

It is believed that the advantages of the technique presented herein will be fully understood from the foregoing description, and it will be apparent that various changes may be made in the form, constructions and arrangement of the exemplary aspects thereof without departing from the scope of the invention or without sacrificing all of its advantageous effects. Because the technique presented herein can be varied in many ways, it will be recognized that the invention should be limited only by the scope of the claims that follow.

1. A method for enabling an application (702) to access a target network function (604) in a visited mobile communication network, the target network function (604) providing a service with respect to one or more wireless devices associated with the application (702) that have roamed from a home mobile communication network to the visited mobile communication network, the method being performed by a network function (602) of the home mobile communication network and comprising:
obtaining (S502) accessibility information on how the target network function (604) can be accessed in the visited mobile communication network; and
providing (S504), based on the accessibility information, access information to the application (702) enabling the application (702) to access the target network function (604).

2. The method of claim 1, wherein the accessibility information is preconfigured in a data repository of the home mobile communication network and wherein obtaining (S502) the accessibility information includes retrieving the accessibility information from the data repository.

3. The method of claim 1, wherein obtaining (S502) the accessibility information includes receiving the accessibility information from a network function (604) of the visited mobile communication network, wherein the network function (604) of the visited mobile communication network provides the accessibility information when the one or more wireless devices register at the visited mobile communication network when roaming from the home mobile communication network to the visited mobile communication network.

4. The method of claim 1, wherein obtaining (S502) the accessibility information includes receiving the accessibility information from a network function (604) of the visited mobile communication network, wherein the network function (604) of the visited mobile communication network provides, upon receiving a request from the network function (602) of the home mobile communication network, a response to the network function (602) of the home mobile communication network including the accessibility information.

5. The method of claim 4, wherein the request and the response are piggybacked on messages exchanged between the network function (602) of the home mobile communication network and the network function (604) of the visited mobile communication network for other purposes than requesting and providing the accessibility information.

6. The method of any one of claims 1 to 5, further comprising:
receiving, prior to obtaining the accessibility information, a subscription request from the application (702) requesting notification in case wireless devices associated with the application (702) have roamed from the home mobile communication network to the visited mobile communication network,
wherein the access information is provided to the application (702) as part of a notification of the subscription.

7. The method of any one of claims 1 to 5, further comprising:
receiving, prior to obtaining the accessibility information, a dedicated request from the application (702) requesting the access information in order to be able to access the target network function (604),
wherein the access information is provided to the application (702) in a dedicated response to the request.

8. The method of any one of claims 1 to 7, wherein the accessibility information includes at least one of:
interaction allowance information indicating whether or not direct interaction between the application (702) and the target network function (604) is allowed, and target network function access information indicating how the target network function (604) can be accessed.

9. The method of claim 8, wherein, when the interaction allowance information included in the accessibility information indicates that direct interaction between the application (702) and the target network function (604) is allowed, the access information provided to the application (702) comprises the target network function access information, enabling the application (702) to directly interact with the target network function (604).

10. The method of claim 8 or 9, wherein, when the interaction allowance information included in the accessibility information indicates that direct interaction between the application (702) and the target network function (604) is not allowed, the access information provided to the application (702) indicates that the application (702) is to indirectly interact with the target network function (604) via the network function (602) of the home mobile communication network.

11. The method of claim 10, further comprising:
receiving, from the application (702), a request to access the target network function (604);
translating the request into a corresponding request to access the target network function (604) in the visited mobile communication network;
sending the translated request to the target network function (604);
receiving, from the target network function (604), a response to the request;
translating the response into a corresponding response to be sent to the application (702); and
sending the translated response to the application (702).

12. The method of claim 11, wherein the response contains information that is filtered by the target network function (604) to avoid exposure of information available in the visited mobile communication network to the home mobile communication network.

13. The method of any one of claims 1 to 12, wherein the network function (602) of the home mobile communication network is a network exposure function, NEF, of the home mobile communication network and wherein the target network function (604) is an NEF of the visited mobile communication network.

14. A method for enabling an application (702) to access a target network function (604) in a visited mobile communication network, the target network function (604) providing a service with respect to one or more wireless devices associated with the application (702) that have roamed from a home mobile communication network to the visited mobile communication network, the method being performed by the application (702) and comprising:
receiving (S902), from a network function (602) of the home mobile communication network, access information enabling the application (702) to access the target network function (604), wherein the access information is provided by the network function (602) of the home mobile communication network based on accessibility information on how the target network function (604) can be accessed in the visited mobile communication network; and
accessing (S904) the target network function (604) using the access information.

15. The method of claim 14, further comprising:
sending, prior to receiving (S902) the access information, a subscription request to the network function (602) of the home mobile communication network requesting notification in case wireless devices associated with the application (702) have roamed from the home mobile communication network to the visited mobile communication network,
wherein the access information is received from the network function (602) of the home mobile communication network as part of a notification of the subscription.

16. The method of claim 14, further comprising:
sending, prior to receiving (S902) the access information, a dedicated request to the network function (602) of the home mobile communication network requesting the access information in order to be able to access the target network function (604),
wherein the access information is received from the network function (602) of the home mobile communication network in a dedicated response to the request.

17. The method of any one of claims 14 to 16, wherein the accessibility information includes at least one of:
interaction allowance information indicating whether or not direct interaction between the application (702) and the target network function (604) is allowed, and
target network function access information indicating how the target network function (604) can be accessed.

18. The method of claim 17, wherein, when the interaction allowance information included in the accessibility information indicates that direct interaction between the application (702) and the target network function (604) is allowed, the access information received by the application (702) comprises the target network function access information, enabling the application (702) to directly interact with the target network function (604).

19. The method of claim 17 or 18, wherein, when the interaction allowance information included in the accessibility information indicates that direct interaction between the application (702) and the target network function (604) is not allowed, the access information received by the application (702) indicates that the application (702) is to indirectly interact with the target network function (604) via the network function (602) of the home mobile communication network.

20. The method of claim 19, wherein accessing the target network function (604) using the access information comprises:
sending, to the network function (602) of the home mobile communication network, a request to access the target network function (604), wherein the request is to be translated by the network function (602) of the home mobile communication network into a corresponding request to access the target network function (604) in the visited mobile communication network, wherein the translated request is to be sent by the network function (602) of the home mobile communication network to the target network function (604); and
receiving, from the network function (602) of the home mobile communication network, a response to the request, the response being originally sent by the target network function (604) and being translated by the network function (602) of the home mobile communication network into a corresponding response to be sent to the application (702).

21. The method of claim 20, wherein the response contains information that is filtered by the target network function (604) to avoid exposure of information available in the visited mobile communication network to the home mobile communication network.

22. The method of any one of claims 14 to 21, wherein the network function (602) of the home mobile communication network is a network exposure function, NEF, of the home mobile communication network and wherein the target network function (604) is an NEF of the visited mobile communication network.

23. A method for enabling an application (702) to access a target network function (604) in a visited mobile communication network, the target network function (604) providing a service with respect to one or more wireless devices associated with the application (702) that have roamed from a home mobile communication network to the visited mobile communication network, the method being performed by the target network function (604) and comprising:
sending (S1002), to a network function (602) of the home mobile communication network, accessibility information on how the target network function (604) can be accessed in the visited mobile communication network, the accessibility information to be used by the network function (602) of the home mobile communication network to provide access information to the application (702) enabling the application (702) to access the target network function (604).

24. The method of claim 23, wherein the accessibility information is sent to the network function (602) of the home mobile communication network when the one or more wireless devices register at the visited mobile communication network when roaming from the home mobile communication network to the visited mobile communication network.

25. The method of claim 23, wherein, upon receiving a request to provide the accessibility information from the network function (602) of the home mobile communication network, a response is sent to the network function (602) of the home mobile communication network including the accessibility information.

26. The method of claim 25, wherein the request and the response are piggybacked on messages exchanged between the network function (602) of the home mobile communication network and the target network function (604) for other purposes than requesting and providing the accessibility information.

27. The method of any one of claims 23 to 26, wherein the accessibility information includes at least one of:
interaction allowance information indicating whether or not direct interaction between the application (702) and the target network function (604) is allowed, and
target network function access information indicating how the target network function (604) can be accessed.

28. The method of claim 27, wherein, when the interaction allowance information included in the accessibility information indicates that direct interaction between the application (702) and the target network function (604) is allowed, the access information provided by the network function (602) of the home mobile communication network to the application (702) comprises the target network function access information to enable the application (702) to directly interact with the target network function (604).

29. The method of claim 27 or 28, wherein, when the interaction allowance information included in the accessibility information indicates that direct interaction between the application (702) and the target network function (604) is not allowed, the access information provided by the network function (602) of the home mobile communication network to the application (702) indicates that the application is to indirectly interact with the target network function (604) via the network function (602) of the home mobile communication network.

30. The method of claim 29, further comprising:
receiving, from the network function (602) of the home mobile communication network, a request to access the target network function (604), the request being originally sent by the application (702) and being translated by the network function (602) of the home mobile communication network into a corresponding request to access the target network function (604) in the visited mobile communication network; and
sending, to the network function (602) of the home mobile communication network, a response to the request, wherein the response is to be translated by the network function (602) of the home mobile communication network into a corresponding response to be sent to the application (702), wherein the translated response is to be sent by the network function (602) of the home mobile communication network to the application (702).

31. The method of claim 30, wherein the response contains information that is filtered by the target network function (604) to avoid exposure of information available in the visited mobile communication network to the home mobile communication network.

32. The method of any one of claims 23 to 31, wherein the network function (602) of the home mobile communication network is a network exposure function, NEF, of the home mobile communication network and wherein the target network function (604) is an NEF of the visited mobile communication network.

33. A computer program product comprising program code portions for performing the method of any one of claims 1 to 32 when the computer program product is executed on one or more computing devices.

34. The computer program product of claim 33, stored on a computer readable recording medium.

35. A computing unit (400) configured to execute a network function (602) of a home mobile communication network for enabling an application (702) to access a target network function (604) in a visited mobile communication network, the target network function (604) providing a service with respect to one or more wireless devices associated with the application that have roamed from the home mobile communication network to the visited mobile communication network, the computing unit (400) comprising at least one processor (402) and at least one memory (404), the at least one memory (404) containing instructions executable by the at least one processor (402) such that the network function (602) of the home mobile communication network is operable to perform the method of any one of claims 1 to 13.

36. A computing unit (410) configured to execute an application (702) for enabling the application (702) to access a target network function (604) in a visited mobile communication network, the target network function (604) providing a service with respect to one or more wireless devices associated with the application (702) that have roamed from a home mobile communication network to the visited mobile communication network, the computing unit (410) comprising at least one processor (412) and at least one memory (414), the at least one memory (414) containing instructions executable by the at least one processor (412) such that the application (702) is operable to perform the method of any one of claims 14 to 22.

37. A computing unit (420) configured to execute a target network function (604) for enabling an application (702) to access the target network function (604) in a visited mobile communication network, the target network function (604) providing a service with respect to one or more wireless devices associated with the application (702) that have roamed from a home mobile communication network to the visited mobile communication network, the computing unit (420) comprising at least one processor (422) and at least one memory (424), the at least one memory (424) containing instructions executable by the at least one processor (422) such that the target network function (604) is operable to perform the method of any one of claims 23 to 32.

38. A system comprising a computing unit (400) according to claim 35, a computing unit (410) according to claim 36 and a computing unit (420) according to claim 37.
